(19) United States
(12) Patent Application Publication
(10) Pub. No.: US 2019/0234443 A1
(43) Pub. Date: Aug. 1, 2019

(54) Connecting Coupler for Steel Reinforcement

(71) Applicant: Silly Goose Ventures, Inc., Chicago, IL (US)

(72) Inventor: Jang Sung Man, Gyeongsangnam-do (KR)

(21) Appl. No.: 16/261,118

(22) Filed: Jan. 29, 2019

(30) Foreign Application Priority Data
Jan. 30, 2018 (KR) 10-2018-0011099
Sep. 14, 2018 (KR) 10-2018-0110074

(51) Int. Cl. F16B 7/18; F16B 7/02; E04C 5/16

(52) U.S. Cl. CPC F16B 7/182; E04C 5/165; F16B 7/02

(57) ABSTRACT

The invention relates to a coupler for reinforcing steel rod connection in construction of a concrete structure. The disclosed coupler includes a housing having a substantially cylindrical interior with a radial lip fixed to an interior sidewall of the housing to separate a first hollow and a second hollow within the interior, a first frustoconical gripping unit with a frame and a plurality of plates positioned against the frame to form sidewalls and define a first cavity, a spring positioned within the housing and biasingly abutting the first frustoconical gripping unit, a center separator positioned within a central coil of the spring and abutting the radial lip on the interior sidewall of the housing, and a second frustoconical gripping unit having a frame and a plurality of plates positioned against the frame to form sidewalls and define a second cavity. The arrangement of components forms two opposing passages into which the reinforcing steel rods are inserted for a stable connection.

### RELATED APPLICATIONS

This application claims the filing benefit of Korean Application No. 10-2018-0011099, filed Jan. 30, 2018, and titled “Reinforcing Coupler,” now Korean Patent No. 10-1866816 issued on Jun. 5, 2018. This application further claims the benefit of Korean Application No. 10-2018-0110074, filed on Sep. 14, 2018 and titled “A One-Touch Type Reinforced Coupler Improved in Reinforcing Bar Coupling Structure.” The Korean '816 patent and the Korean '074 application are both hereby incorporated by reference in their entireties.

### TECHNICAL FIELD OF THE INVENTION

The present invention relates to a coupler. Particularly, the application relates to a device to quickly, easily and securely couple two steel rods together, without requiring a weld.

### BACKGROUND OF THE INVENTION

In large construction projects there is often a need to connect multiple steel rods (a.k.a., rebar) for support purposes. There is a need for multiple connected steel rods in concrete, steel, and even wood projects. However, the current processes and devices used to connect steel rods are often burdensome and time consuming. For example, reinforcing bars were bundled and fixed using wire. Such a wire fixing method requires manual work by an operator. Not only is this method time consuming, but the resulting coupled rebar components are not placed on the same straight line which results in a tilting to a side. Accordingly, there is a need for an improved steel rod coupler and a method for making and using such a coupler.

Furthermore, current process and devices used to couple steel rods often result in unstable connections. This instability can jeopardize reinforcement and the structural integrity of the project. Accordingly, there is a need for a steel rod coupler that provides better stability for construction projects, leading to safer working areas.

Until the invention of the present application, these and other problems in the prior art went either unnoticed or unsolved by those skilled in the art. The present invention provides a steel rod coupler which outperforms prior devices and methods without sacrificing safety, stability, easy-of-use, or affordability.

### SUMMARY OF THE INVENTION

There is disclosed herein a coupler for steel rods which avoids disadvantages of prior devices, components and methods while affording additional structural, installation and operating advantages.

Generally speaking, the device is comprised a housing having a hollow interior, a first and second gripping unit, an elastic spring, and a finishing cap.

In a preferred embodiment, the disclosed coupling device for coupling two rods together at respective ends comprises a housing having a substantially cylindrical interior with a radial lip fixed to an interior sidewall of the housing to separate a first hollow and a second hollow within the interior of the housing and an end cap on each of two opposing ends of the housing, wherein one end cap is fixed in place and one end cap is removable from an end of the housing to provide access to the first and second hollows on the interior of the housing, a first frustoconical gripping unit comprised of a frame and a plurality of plates positioned against the frame to form sidewalls and define a first cavity, the first frustoconical gripping unit being positioned within the first hollow of the housing proximate the fixed end cap, a spring positioned within the housing and biasingly abutting the first frustoconical gripping unit, a center separator positioned within a central coil of the spring and abutting the radial lip on the interior sidewall of the housing, and a second frustoconical gripping unit comprised of a frame and a plurality of plates positioned against the frame to form sidewalls and define a second cavity, the second frustoconical gripping unit being positioned within the second hollow of the housing and abutting an end of the spring.

In a preferred embodiment, each of the plurality of plates of the first and second gripping units comprises a plurality of ridges facing inward toward the first cavity and second cavity, respectively. The ridges of the plurality of plates engage the substantially cylindrical rod inserted into the cavity of each gripping unit.

In another specific embodiment, each of the end caps comprises an opening which allows a substantially cylindrical rod to be interested into the cavity of each of the gripping units within the first and second hollows of the housing.

In an alternate embodiment, the elastic spring might be replaced by a foam insert, or any mechanism that sufficiently biases the steel rod.

These and other aspects of the invention may be understood more readily from the following description and the appended drawings.

### BRIEF DESCRIPTION OF THE DRAWINGS

For the purpose of facilitating and understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a perspective view showing an embodiment of the disclosed coupler;

FIG. 2. is a perspective view showing the coupler embodiment of FIG. 1 including two reinforcement rods connected in the coupler;

FIG. 3 is an exploded view of the embodiment of the coupler shown in FIG. 1;

FIG. 4 is a perspective view of an embodiment of the frame used for a gripping unit of the disclosed coupler for a reinforcing rod connection;

FIG. 5 is an exploded view of an embodiment of a gripping unit of the disclosed coupler for a reinforcing rod connection;

FIG. 6 is a side cross section of the coupler shown in FIG. 1, with a close up view of a lip and central separator within the housing of the coupler;

FIG. 7 is a perspective view of an embodiment of a central separator used in the disclosed coupler device; and

FIGS. 8a-8e are side cross sections of the coupler of FIG. 1 illustrating the insertion of reinforcing rods into the ends of the coupler.

### DETAILED DESCRIPTION OF THE EMBODIMENTS

While this invention is susceptible of embodiments in many different forms, there is shown in the drawings and will herein be described in detail at least on preferred embodiment of the invention with the understanding that the present disclosure is to be considered as an exemplification of the principles of the invention and is not intended to limit the broad aspect of the invention to any of the specific embodiments illustrated.

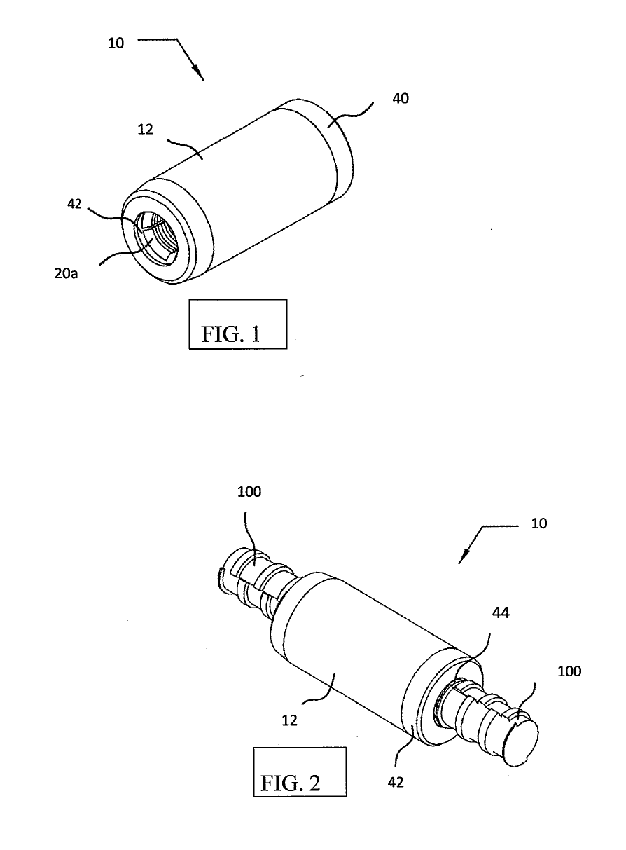

With reference to FIGS. 1-7, the invention relates to a coupler 10 used for coupling two lengths of reinforcement steel rod (aka, rebar) (100) in construction for, e.g., a concrete structure. The coupler 10 comprises a housing 12, two gripping units 20, a center separator 30, a spring 32 (or other suitable elastic member), and end caps 40, 42 with openings 44 at each end. End cap 40 is removable, while end cap 42 is fixed to the housing 12.

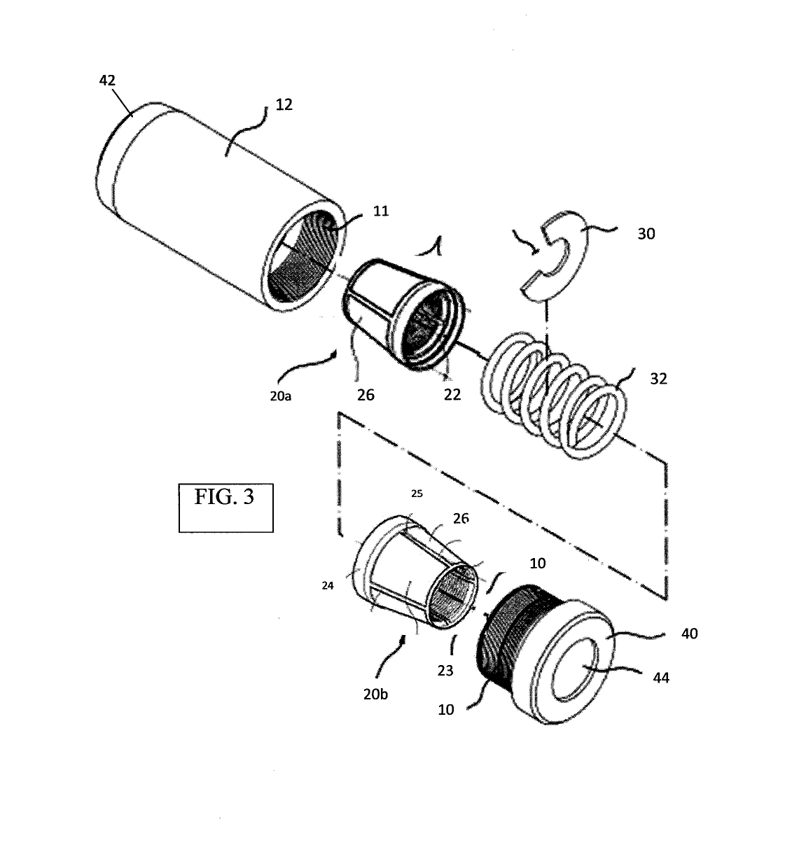

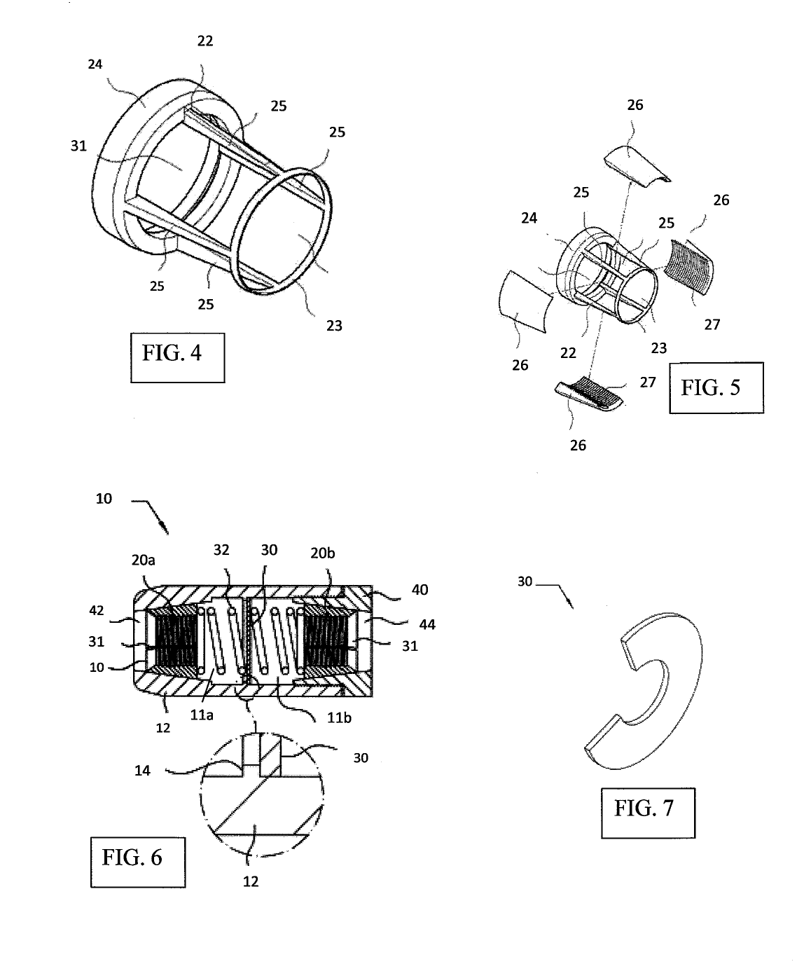

As shown in FIGS. 4 and 5, the gripping units 20 are comprised of a frame 22 having a first circular end 23 and a larger second circular end 24 connected by legs 25 to define a plurality of open, rectangular spaces. Within these spaces are positioned curved plates 26, having a plurality of ridges 27 thereon, to form a cavity within each of the gripping units 20. The ridges 27 face inward to the cavity. When constructed, as shown in FIG. 3, the frame 22 and plates 26 give the gripping units 20 a truncated cone, or frustoconical shape.

The coupler 10 is constructed in a manner as shown in FIG. 3. The first of the gripping units 20a is positioned within the housing 12 of the coupler 10 to abut the fixed end cap 42, followed by the spring 32, center separator 30, and the second gripping unit 20b. The components reside within a hollow 11, which is bisected by radial rib 14 (FIG. 6) on an interior surface of housing 12 creating a first hollow 11a and a second hollow 11b, which is formed in a longitudinal direction within the coupler housing 12.

As illustrated in FIG. 6, the aforementioned truncated cone shape—i.e., frustoconical—of the gripping units 20 permits them to be placed securely within each of the end-tapered first and second hollows 11a and 11b, respectively, of the housing 12. Furthermore, the gripping units 20 each have an opening 31 which aligns with an opening at the end of the housing 12 to define a passage there through. The resultant cylindrical passages at each end of the housing 12 are formed to allow insertion of a pair of reinforcement steel rod (100) to be coupled together.

As further shown in FIG. 6, the two gripping units 20 are separated within the hollow by an elastic spring 32 and center separator 30. The components are held within the respective hollow by securing removable end cap 40, which is preferably threaded, to the open end of housing 12.

The center separator 30 of FIG. 7 is preferably C-shaped to allow it to be inserted within the coil of spring 32. However, if other biasing means are used instead of a spring, the center separator 30 may be a solid circle or some variation which will, still be able to abut the interior rib 14 of housing 12.

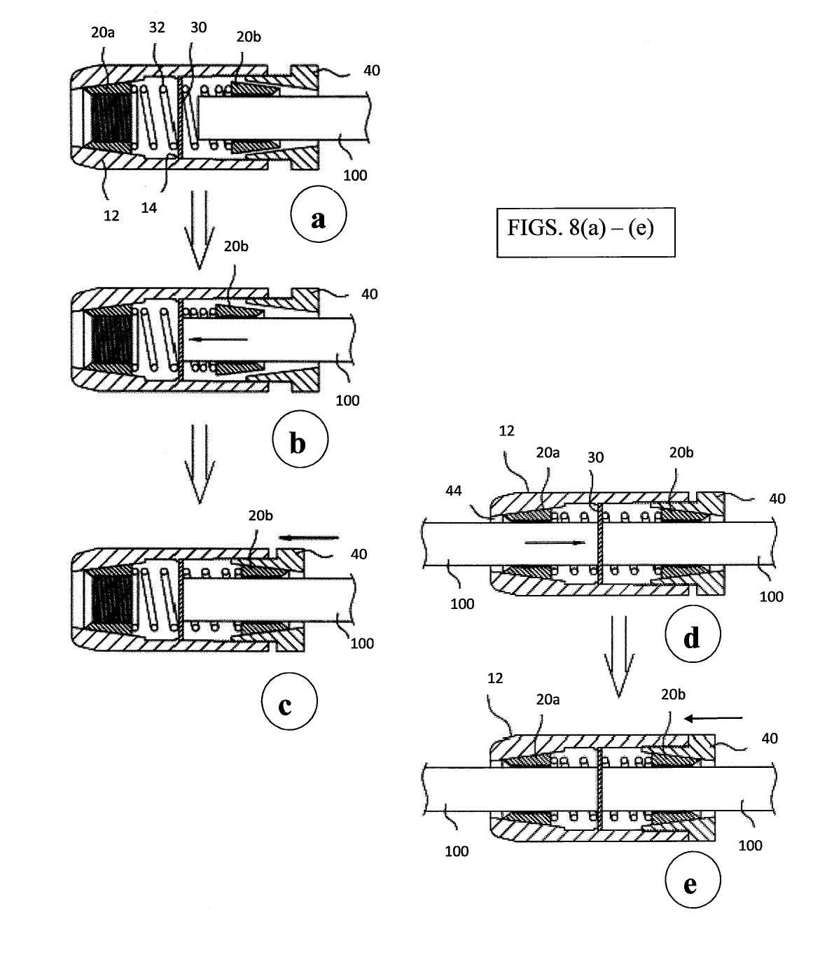

As shown in FIGS. 8a-8e, the C-shaped center separator 30 is positioned in the center of a biasing spring 32 within the hollow 11 to abut against lip 14. To begin the coupling of two reinforcement steel rods (100), an end of a first reinforcement steel rod (100) is inserted through the opening in the loosened removable end cap 40 until it passes through the passage of the gripping unit 20b and abuts the center separator 30 (FIGS. 8a, 8b). As the removable end cap 40 is tightened, the gripping unit 20 is forced toward the center separator 30 (FIG. 8c). The ridges 27 of the plates 26 bind to the steel rod (100) and secure it within the housing 12. A second steel rod (100) is then inserted into the opposing end of the housing 12 until it passes through the second gripping unit 20a and abuts the center separator 30 (FIG. 8d). Finally, the end cap 40 is tightened completely and the coupling of the two steel rods (100) is complete.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A device for coupling two rods together at respective ends, the device comprising:
a. a housing having a substantially cylindrical interior, a radial lip fixed to an interior sidewall of the housing to separate a first hollow and a second hollow within the interior of the housing, and an end cap on each of two opposing ends of the housing, wherein one end cap is fixed in place and one end cap is removable from an end of the housing to provide access to the first and second hollows on the interior of the housing;
b. a first gripping unit comprised of a frame and a plurality of plates attached to the frame to form sidewalls and define a first cavity, the first gripping unit being positioned within the first hollow of the housing proximate the fixed end cap;
c. a spring positioned within the housing and biasingly abutting the first gripping unit;
d. a center separator positioned within a central coil of the spring and abutting the radial lip on the interior sidewall of the housing; and
e. a second gripping unit comprised of a frame and a plurality of plates attached to the frame to form sidewalls and define a second cavity, the second gripping unit being positioned within the second hollow of the housing and abutting an end of the spring.

2. The device of claim 1, wherein the first and second gripping units have a frustoconical shape.

3. The device of claim 1, wherein the plurality of plates of the first and second gripping units comprise ridges facing inward toward the first cavity and second cavity, respectively.

4. The device of claim 1, wherein the removable end cap is threadably engaged to the housing end.

5. The device of claim 2, wherein each of the plurality of plates has a concave shape.

6. The device of claim 1, wherein the center separator has a C-shape.

7. The device of claim 2, wherein each of the end caps comprises an opening which allows a substantially cylindrical rod to be interested into the cavity of each of the gripping units within the first and second hollows of the housing.

8. The device of claim 7, wherein the ridges of the plurality of plates engage the substantially cylindrical rod inserted into the cavity of each gripping unit.

9. The device of claim 1, wherein the plurality of plates are detachable from the frame for both the first and second gripping units.

10. A coupler device for securely holding two rods together at respective ends, the coupler device comprising:
a. a cylindrical housing having a substantially cylindrical interior, a radial lip fixed to an interior sidewall of the housing to divide the interior into a first hollow and a second hollow of substantially equal dimensions, and an end cap on each of two opposing ends of the housing, the end caps having openings there through and wherein one end cap is fixed to the housing and one end cap is removable from an end of the housing to provide access to the first and second hollows on the interior of the housing;
b. a first frustoconical gripping unit open on two opposing ends and comprised of a frame and a plurality of concave plates attached to the frame to form sidewalls defining a first cavity, the first frustoconical gripping unit being positioned within the first hollow of the housing proximate the fixed end cap;
c. a spring positioned within the housing and biasingly abutting the first frustoconical gripping unit;
d. a center separator positioned within a central coil of the spring and abutting the radial lip on the interior sidewall of the housing; and
e. a second frustoconical gripping unit comprised of a frame and a plurality of plates attached to the frame to form sidewalls and define a second cavity, the second gripping unit being positioned within the second hollow of the housing and abutting an end of the spring.

11. The device of claim 1, wherein the plurality of plates of the first and second gripping units comprise ridges facing inward toward the first cavity and second cavity, respectively.

12. The device of claim 1, wherein the removable end cap is threadably engaged to the housing end.

13. The device of claim 2, wherein each of the plurality of plates has a concave shape.

14. The device of claim 1, wherein the center separator has a C-shape.

15. The device of claim 2, wherein each of the end caps comprises an opening which allows a substantially cylindrical rod to be interested into the cavity of each of the gripping units within the first and second hollows of the housing.

16. The device of claim 7, wherein the ridges of the plurality of plates engage the substantially cylindrical rod inserted into the cavity of each gripping unit.
